(19) United States
(12) Patent Application Publication
(10) Pub. No.: US 2025/0270721 A1
(43) Pub. Date: Aug. 28, 2025

(54) ELECTROCHEMICAL DEVICE FOR PRODUCTION OF HYDROGEN AND ELECTRICAL ENERGY

(71) Applicants: Robert Bado, Delray Beach, FL (US); Artem Madatov, North Bethesda, MD (US)

(72) Inventors: Robert Bado, Delray Beach, FL (US); Artem Madatov, North Bethesda, MD (US)

(21) Appl. No.: 18/588,444

(22) Filed: Feb. 27, 2024

(51) Int. Cl. C25B 15/021; C25B 1/02; C25B 15/027; H01M 8/0656

(52) U.S. Cl. CPC C25B 15/021; C25B 1/02; C25B 15/027; H01M 8/0656; H01M 2220/20

(57) ABSTRACT

The invention provides a high-capacity, dry-charged, ready-for-instant-activation-by-adding-water, recyclable and safe electrochemical device and a method for producing hydrogen and electrical energy on demand, based on electrochemical interactions of magnesium, water and sulfuric acid, with an automatic control of the electrolyte's temperature, acidity and level inside the device.

### FIELD OF THE INVENTION

The invention relates to the energy industry, in particular to an electrochemical device and method for producing hydrogen and electrical energy.

### BACKGROUND OF THE INVENTION

Vehicles powered by various types of energy are known from the prior art. Air pollution by internal combustion engines is an enormous environmental problem. Ever-shrinking resources of fossil fuels worsen the problem at hand. Vehicles powered exclusively by electricity, in turn, do not have such a problem. However, relatively low battery capacity, short service life, high cost of raw materials, shortage of raw materials, as well as significant fire hazard of these batteries triggered a search for other types of fuel and methods to store energy aboard a vehicle.

One of the well-known sources of “clean” energy is hydrogen, since its oxidation with atmospheric oxygen produces only water. Moreover, the calorific value of hydrogen is extremely high −141 MJ/kg.

However, an exceptionally low density of gaseous hydrogen and its high diffusivity under pressure make hydrogen storage a particularly difficult problem. For example, to store hydrogen at a normal ambient temperature, a pressure of more than 60 MPa is required. On the other hand, it is no less dangerous to store hydrogen aboard in its liquid state, because its storage requires a low temperature of lower than −252.9° C. (−423° F.).

When the temperature rises, the liquid hydrogen boils continuously, necessitating release of constantly evaporating gaseous hydrogen to the atmosphere.

A safer way to power a vehicle's hydrogen engine or hydrogen fuel cells is to avoid storing hydrogen aboard, but rather producing it aboard on demand.

The most common method of green hydrogen production is through a chemical process known as electrolysis. This method uses an electric current to separate the hydrogen from the oxygen in water. To avoid an explosion, it is essential to ensure that hydrogen does not contain a slightest admixture of oxygen. Hydrogen from a cathode space of the electrolyzer is pumped into storage cylinders under a high pressure of 150 to 700 bar. However, the cost of electricity for compressing hydrogen amounts to 30 to 60% of the total energy that can then be obtained from the oxidation of this quantity of hydrogen. At the same time, the high-pressure cylinder itself poses a danger, especially during the road accidents.

A safer way to store hydrogen is the reversible binding of hydrogen in transition metal hydrides under fairly low pressure up to 10 bar. The hydrogen content in metal hydrides of intermetallic compounds of titanium, chromium, and vanadium reaches 7% by weight, and it can be released in the form of gas when heated. However, in presence of traces of moisture in hydrogen, the intermetallic compounds quickly degrade and lose their ability to bind hydrogen.

Liquefying hydrogen at −253° C. (−423° F.) does not solve the problem either. Despite careful thermal insulation of a Dewar flask aboard a car, liquid hydrogen still boils continuously, regardless of whether the vehicle is in motion or motionless. The evaporated hydrogen is drained into the environment, creating an explosive hazard of hydrogen/air mixture.

Onboard production of hydrogen from chemicals such as methanol or hydrazine, using catalysts, is environmentally harmful, hazardous to people, and expensive. Production of hydrogen by reacting water with alkali or alkaline earth metal hydrides is too expensive and dangerous due to the uncontrolled reaction, which often ends in explosion.

Electrolysis of water using energy stored in a vehicle battery does not make sense, because it is much easier to use electrical energy directly to power electric motors, in electric cars.

The present inventors established the following requirements for the present invention:
The device must be portable to conveniently fit within a compact passenger car;
The rate of hydrogen evolution reaction must be sufficient to provide enough power to the vehicle's power unit of not less than 30 kW;
The hydrogen evolution reaction must be manageable, i.e. the hydrogen release rate should vary on demand from 0 to 100% output;
The device must not contain or consume expensive, rare, toxic and hazardous substances;
The device must be simple, reliable and cheap.

The present inventors took into account that a 2-ton car requires about 300 MJ of energy for a 600-mile driving range. This amount of energy can only be obtained by carrying out chemical oxidation-reduction reactions, including electrochemical reactions. The managed conversion of chemical energy into electricity is only possible in electrochemical devices. Hence, the present inventors focused their efforts on developing an electrochemical cell that produces hydrogen.

Magnesium is one of the most energy-intensive materials for chemical sources of electrical energy—about 1100 Wh/kg. In addition, magnesium does not corrode in air or room-temperature water.

A so-called Sea Water Battery is disclosed in the United States patent U.S. Pat. No. 3,941,616A, which has a battery cell system with electrode plates, preferably magnesium and silver chloride plates, and using as electrolyte a solution of chemicals introduced from the outside into its cell system.

The present inventors consider the above stated patent as a prototype of their invention. The said Sea Water Battery has magnesium metal anodes, cathodes containing silver chloride as electron acceptor and a liquid electrolyte in the form of seawater with additives. The battery can be stored dry for a long time without self-discharge. To activate the battery, a reservoir with the electrodes is filled with sea water, and oxidation of the anodes and reduction of the cathodes begins. When an electrical load is introduced, a current in the circuit is caused by a difference in standard electrode potentials of magnesium and silver chloride in an aqueous solution of sodium chloride. Once the active materials are used up, the used battery is disposed of.

Despite a simplicity of the device and its principle of operation, the said battery has significant disadvantages. Firstly, it cannot be recharged by electric current, as metallic magnesium is not released by electric current at the cathode from aqueous solutions of magnesium salts, hydrogen is released instead. Magnesium can only be extracted from molten magnesium salts at a temperature of about 700° C. (1292° F.). Secondly, metallic silver does not dissolve in a chloride electrolyte due to passivation of the silver electrode. In addition, using silver in disposable batteries is prohibitively expensive.

Thus, the present inventors managed to reduce the electrochemical cell weight and increase its specific energy to about 800 Wh/kg. A fully charged battery of said cells could support a 600-1000-mile vehicle driving range. The discharged cells could quickly be replaced with charged ones at, for example, any gas station. The present inventors developed a high-capacity recyclable and safe electrochemical cell for production of hydrogen and electrical energy aboard a vehicle, that can power both electric motors and hydrogen engines.

### SUMMARY OF THE PRESENT INVENTION

The invention provides a high-capacity recyclable and safe electrochemical device and a method for producing hydrogen and electrical energy on demand, based on electrochemical interactions of magnesium, water and sulfuric acid.

Each dry-charged cell, ready for an instant activation by adding water to it, contains a magnesium anode and crystalline ammonium sulfate in a water-soluble bag, and could be stored for an unlimited period of time without any self-discharge.

Energy is stored inside the dry-charged cell in form of magnesium metal, water and sulfuric acid, stored separately from each other. When a metallic magnesium, water and sulfuric acid are combined within a cell, the energy is released as electricity and hydrogen. After complete dissolution of magnesium, the electrolyte containing magnesium-diammonium sulfate can be recycled and re-processed into metallic magnesium, ammonium sulfate and sulfuric acid.

Each cell consists of a sealed metal case, a magnesium anode, a water-hydrogen cathode, an aqueous electrolyte. The case is made of a thin iron sheet coated on the inside with an anti-corrosion coating. The cell is also equipped with pipes for releasing hydrogen from the cell and delivering water into the cell, as well as electrolyte circulation. Insulated from the case, anode and cathode electrodes are connected to outside terminals.

Energy extraction is carried out as follows: new dry-charged cells are installed in the car battery unit. The connection terminal of each cell is serially connected with a battery electrical wiring and the entire battery is connected to a controller. The hydrogen releasing pipe of each cell is connected through a secure coupling to a hydrogen manifold. The electrolyte inflow and outflow pipes are connected to an electrolyte circulation. The battery is filled with water through a delivery pipe connected to a vehicle water tank, so the dry ammonium sulfate pre-placed inside each cell in the water-soluble bags, dissolves in the water, and the electrolyte is created. The entire battery activation process takes about 5 minutes. As a result, standard electrical potentials appear at the electrodes. The potential difference between cathode and anode in each cell is approximately 2.37 V. The battery is ready for use.

For a hydrogen-electric hybrid passenger vehicle with a mass of up to 2 tons, the aboard battery should consist of about 20 said electrochemical cells, delivering about 84 kWh or 300 MJ of energy, with a consumption of around 14 kWh per 100 miles, thus securing around 600 miles of driving range.

### BRIEF DESCRIPTION OF THE DRAWINGS

FIG. 1 is a schematic drawing of the electrochemical cell for producing hydrogen and electrical energy on demand

### DETAILED DESCRIPTION OF THE INVENTION

The invention provides a high-capacity recyclable and safe electrochemical cell and a method for producing hydrogen and electrical energy on demand, based on electrochemical interactions of magnesium, water and sulfuric acid.

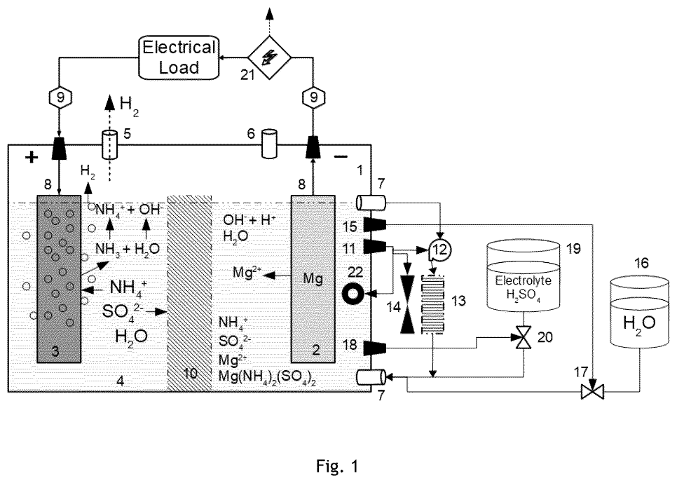

Each cell (FIG. 1) consists of a sealed metal case 1, a magnesium anode 2, a water-hydrogen cathode 3, an aqueous electrolyte 4. The case is made of a thin iron sheet coated on the inside with an anti-corrosion coating. The cell is also equipped with a hydrogen releasing outlet 5 and a water delivering outlet 6, as well as electrolyte circulation outlets 7. Insulated from the case, anode and cathode electrodes 8 are connected to outside electrical terminals 9.

The anode 2 is made of high-purity magnesium as a set of thin rectangular vertically-placed parallel plates, with spaces between them for placing cathode plates 3 and separators 10. All anode plates are galvanically connected to each other at the top using a busbar. The electric current output extends upward from the busbar. The anode block is made by injection molding.

The cathode is made of iron mesh. The cathode consists of a plurality of rectangular vertically-placed parallel to each other mesh plates connected by an iron busbar. The cathode is coated with a thin layer of electroplated nickel in order to reduce hydrogen evolution overvoltage and increase the energy efficiency of the cell.

The electrode assembly is placed within the cell case in such a way so that the anode and cathode plates alternate with each other, and separators 10 are inserted between them. The separators are made of corrugated polypropylene mesh. Separators prevent short circuiting of the anode and cathode, and, at the same time, ensure the flow of electrolyte and the movement of hydrogen bubbles between the plates. The electrode assembly, placed inside the cell case, is fixed at place by plastic spacers. A necessary quantity of crystalline ammonium sulfate, packed in a water-soluble bag, is also placed inside the cell case. The cell case is hermetically sealed.

Each dry-charged cell can be stored for an unlimited period of time without any self-discharge.

The cell is equipped with devices for thermoregulation, devices for supplying water and acid (regenerated electrolyte) and devices for regulating the rate of hydrogen production.

The device for regulating the electrolyte temperature consists of a temperature sensor 11, a circulation pump 12, an air radiator 13 with a fan 14.

The device for adding water consists of an electrolyte level sensor 15, a reserve tank with water 16, and a solenoid valve 17 connected to the electrolyte level sensor.

The device for adding acid (regenerated electrolyte) consists of an acidity (pH) sensor 18, a reserve tank 19 with acid (regenerated electrolyte), and a solenoid valve 20 connected to the acidity sensor.

The device for regulating hydrogen production rate consists of a controller 21 connected to a vehicle's accelerator (not shown).

New dry-charged cells, about twenty units per a 2-ton passenger vehicle, are to be inserted into a vehicle battery slots, and get connected in series to increase the battery's overall voltage. The battery is connected to the controller 21. The hydrogen releasing pipes 5 get connected via hermetic couplings to the hydrogen manifold and the valves get opened. The electrolyte circulation pipes 7 get connected to the corresponding manifolds for the inflow and outflow of the electrolyte. Each cell is getting filled with water from the tank 16, and the dry ammonium sulfate in the bags dissolves in the water and the electrolyte is created. The entire cell activation process would take about 5 minutes. Standard electrical potentials appear at the electrodes. Between cathode and anode in each cell the potential difference is approximately 2.37 Volts (in a slightly acidic environment). The battery is ready for use.

When the vehicle starts, the controller 21 passes an electric current from the battery to the on-board electrical load: electrical and electronic devices, air conditioning, traction motors, etc. The electrons are removed from the atoms of magnesium on the anode 2, and move through the external electrical load to the cathode 3. Magnesium dissolves on the surface of the anodes, and magnesium cations move through the electrolyte towards the cathodes:

Mg−2e=>Mg²⁺

The standard electrode potential of magnesium in a slightly acidic environment is approximately 2.37 Volts, and in an alkaline environment −2.69 Volts.

Simultaneously, under the influence of an electric field, hydrogen cations and ammonium cations approach the cathode 3. Electrons arriving at the cathode through an external electric circuit discharge hydrogen and ammonium cations:

2NH₄⁺+2e=>2NH₃+H₂

2H⁺+2e=>H₂

Hydrogen is released at the cathode 3, which rises to the surface of the electrolyte. Hydrogen accumulates under a lid of the cell case 1, and is evacuated through pipe 5 to power the vehicle's power plant. The ammonia formed during the discharge of ammonium ions immediately dissolves in water and again forms ammonium ions and hydroxyl ions:

NH₃+H₂O=>NH₄⁺+OH—

The discharge potential of ammonium and hydrogen ions depends on the pH of the electrolyte, the more acidic the environment, the less negative the discharge potential of ions with the reduction of hydrogen to a free state. In an acidic environment, the potential for the reduction reaction of hydrogen ions is 0 Volt. However, too much acidification of the electrolyte contributes to high a high self-discharge level, and excessively alkaline environment causes magnesium ions to precipitate as magnesium hydroxide. Optimal for normal battery operation is an electrolyte with pH of 6.5-7.5.Due to hydrogen reduction at the cathode, the electrolyte becomes alkalized, and the buffer capacity of ammonium sulfate in the electrolyte will sooner or later be exhausted, acid must be added to adjust the pH of the electrolyte. Regenerated electrolyte with a high content of sulfuric acid is used as an acid additive. When the pH of the electrolyte increases above 7.5, the pH sensor 18 sends a signal to the electric valve 20 of the acid tank 19 and the acid solution enters the battery. When the pH of the electrolyte reaches 6.5, the pH sensor 18 closes the electric valve 20.

The thermoregulation system also works automatically. When the electrolyte temperature reaches +50° C., the temperature sensor 11 turns on the circulation pump 12 and the fan 14. The pump 12 pumps out the electrolyte from the upper pipe 7, through the radiator 13 and returns it to the cell through the lower pipe 7. The air cools down the electrolyte passing through the radiator so the electrolyte temperature drops. When the electrolyte temperature drops to +20° C., the sensor 11 turns off the electrolyte circulation pump 12 and the fan 14.

The potential difference across the cell in the presence of current in the circuit is 2.2-2.3 Volts (depending on temperature and pH), and at the full load of the external circuit it drops 1.4-1.5 Volts, i.e. at least 35% of the cell's energy is converted into heat inside the cell. Therefore, the excessive thermal energy must be dissipated through the radiator.

At temperatures below 0° C., when the vehicle starts, the same sensor 11 turns on the electrolyte electric heater (not shown), and when the electrolyte temperature rises to +20° C., the sensor turns off the electric heater 22. As a result, the operating temperature of the battery ranges from +20° C. to +50° C., which is an optimal range for hydrogen production. Within said thermal range there is no self-discharge of the battery, thus, there is no spontaneous dissolution of magnesium and release of hydrogen in the absence of current in the external circuit.

During the production of hydrogen, in addition to magnesium, water is also consumed. Adding water from the reserve tank 16 is controlled by the electrolyte level sensor 15 through the electric valve 17. The same electric valve 17 is used to drain the electrolyte from the cell case 1 into the reserve tank 16 during a multi-day parking of the vehicle to avoid significant loss of battery charge due to self-discharge. The used electrolyte is drained when replacing the cell.

All materials utilized in the device are reusable and there is no waste.

Thus, the present inventors solved the problem of creating a high-capacity recyclable and safe electrochemical device and a method for producing hydrogen and electrical energy, based on electrochemical interactions of magnesium, water and sulfuric acid.

Combination of known features in one system led to qualitatively new results:
Storage and transportation of hydrogen and electrical energy in the form of magnesium has become compact, cheap and safe;
Control of hydrogen release has become a more reliable way of regulating the anode current;
Thanks to the release of a portion of energy in the form of electric current, it became possible to double the production of hydrogen from the same amount of magnesium, namely up to 8 mass percent;
The system uses the same cheap and abundant materials repeatedly and without waste;

1. An electrochemical device comprising at least one magnesium or magnesium alloy anode, at least one cathode consisting of an electrically conductive base and an electron acceptor, immersed in a discharge bath of liquid electrolyte containing magnesium ions, characterized in that the liquid electrolyte contains a soluble ammonium salt.

2. The device according to claims 1, characterized in that the discharge bath is a hermetically sealed housing with a hydrogen releasing outlet, a water delivering outlet and electrolyte circulation outlets.

3. The device according to claim 1, characterized in that the water-based electrolyte, the cathode is immersed in, also acts as the cathode's electron-accepting material, reduced to hydrogen and hydroxyl.

4. The device according to claim 1, characterized in that the liquid electrolyte is an aqueous solution of ammonium sulfate at a concentration of 10%-70% and magnesium ammonium sulfate at a concentration of more than 0% and less than 70%.

5. The device according to claim 1, characterized in that it is equipped with an automatic electrolyte temperature control system, consisting of an air radiator with a fan, a circulation pump, an electric heater and a temperature sensor, to maintain the electrolyte optimal temperature within +20° C. and +50° C.

6. The device according to claim 1, characterized in that it's equipped with electrolyte level sensors and outflow and inflow outlets with valves for automatically regulating the liquid electrolyte level in the discharge bath.

7. The device according to claim 1, characterized in that it's equipped with an aqueous acid solution reserve tank with valves, and a pH sensor to open the valves when the electrolyte pH reaches above 7.5 and to close the valves when the electrolyte pH drops below 6.5.

8. The device according to claim 1, characterized in that it's equipped with an external circuit electric current regulator to regulate the hydrogen evolution mass rate by changing the value of the anode current.
